(19) United States
(12) Patent Application Publication
(10) Pub. No.: US 2006/0084178 A1
(43) Pub. Date: Apr. 20, 2006

(54) Trace ammonia colorimetric test apparatus

(76) Inventors: Barbara M. Peyton, Windsor, CT (US); John W. Steele, New Hartford, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/966,654

(22) Filed: Oct. 15, 2004

(51) Int. Cl. G01N 21/00

(52) U.S. Cl. 436/165

(57) ABSTRACT

A chemical measuring apparatus and method that include a flexible sample bag for unmasking and measuring an amount of a chemical in a sample while under microgravity conditions. The sample includes a biocide that masks the presence of the chemical in the sample. The flexible sample bag includes first and second fluidly connectable chambers. The first chamber includes a pH adjuster for adjusting the pH of the sample, thereby unmasking the presence of a chemical in the sample. The second chamber includes a chemical measuring device and indicator for measuring the amount of the chemical in the sample.

### BACKGROUND OF THE INVENTION

This invention relates to measurement of ammonia in an aqueous-based sample and, more particularly, to measuring the amount of ammonia in a biocide-containing aqueous sample under microgravity conditions.

Outer space structures, such as the International Space Station, include thermal control systems for maintaining predetermined operating temperatures for various support systems used in the space structure. The thermal control systems typically include an aqueous-based coolant that circulates between a support system and an external anhydrous ammonia system, with a heat exchanger to transfer heat away from the support system and maintain the predetermined operating temperature.

Typically, an occupant of the outer space structure measures the amount of ammonia in the aqueous-based coolant at regularly scheduled intervals using a colorimetric test strip to ensure there has been no leakage between the two systems. The aqueous-based coolant contacts a colorimetric test strip and any ammonia that is present in the aqueous-based coolant changes the color of the calorimetric test strip. The operator then compares the color to a color-coded indicator to determine the amount of ammonia in the aqueous-based sample. A higher than expected amount of ammonia may indicate that the anhydrous ammonia has leaked into the aqueous-based coolant through a pinhole or crack in the heat exchanger between the two systems, potentially leaking ammonia into the aqueous-based coolant and into the crew cabin through a phase-separator gas trap.

Use of a biocide in the aqueous-based coolant has been proposed to destroy contaminating biological organisms that may degrade the performance of the thermal control system. In one example, the biocide includes glutaraldehyde, which has been shown experimentally by applicants to mask the presence of ammonia in the aqueous-based coolant such that a measurement of the amount of ammonia shows no ammonia or an amount of ammonia that is lower than the actual amount of ammonia in the aqueous-based coolant. As a result, the presence of ammonia in biocide-containing aqueous-based coolants might not be identified and the underlying potential leakage of ammonia into the crew cabin would not be detected.

Accordingly, a method and apparatus for more accurately measuring the amount of ammonia in a biocide-containing aqueous-based coolant is needed.

### SUMMARY OF THE INVENTION

The chemical measuring apparatus according to the present invention includes a flexible sample bag with an inlet for introducing a sample. The inlet includes a cap tethered to the inlet for covering the inlet. The flexible sample bag includes a first chamber and a second chamber that is fluidly connectable to the first chamber. The first chamber includes a pH adjuster for adjusting the pH of the sample. A closure member is removably positioned between the first chamber and second chamber to selectively prevent or allow fluid flow between the first chamber and the second chamber. The second chamber includes a chemical measuring device and indicator for measuring the amount of ammonia in the sample.

Operationally, the sample is introduced into the first chamber and the cap is closed over the inlet. The sample is then manually manipulated through the flexible sample bag to contact the pH adjuster and adjust the pH of the sample. The closure member is removed and the adjusted pH sample is manipulated into the second chamber. The sample is manipulated in the second chamber to contact the chemical measuring device. The sample is then manually pushed away from the ammonia concentration test pad and the closure member is then re-positioned between the first chamber and second chamber. The user then compares the color change observed on the ammonia concentration test pad to an adjacent ammonia concentration color indicator chart. The sample containment bag with sample is then stored for subsequent disposal.

In one example, the sample to be measured is an aqueous-based coolant sample that includes a biocide that masks the presence of ammonia by preventing accurate measurement of the amount of ammonia. The amount of ammonia is unmasked by changing the pH of the aqueous-based coolant sample using a sodium hydroxide pH adjuster in the first chamber. The pH adjusted aqueous-based coolant sample contacts a calorimetric test strip in the second chamber. The calorimetric test strip changes color in response to contact with the pH adjusted aqueous-based coolant sample. The resulting color of the colorimetric test strip is compared to an adjacent indicator to determine the amount of ammonia.

The chemical measuring apparatus and method according to the present invention provide for measurement of an amount of ammonia present in a biocide-containing sample.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 illustrates a schematic view of an exemplary thermal control system; and

FIG. 2 illustrates a cross-sectional schematic view of a flexible sample bag used to measure an amount of ammonia in an aqueous-based coolant.

### DETAILED DESCRIPTION OF THE PREFERRED EMBODIMENT

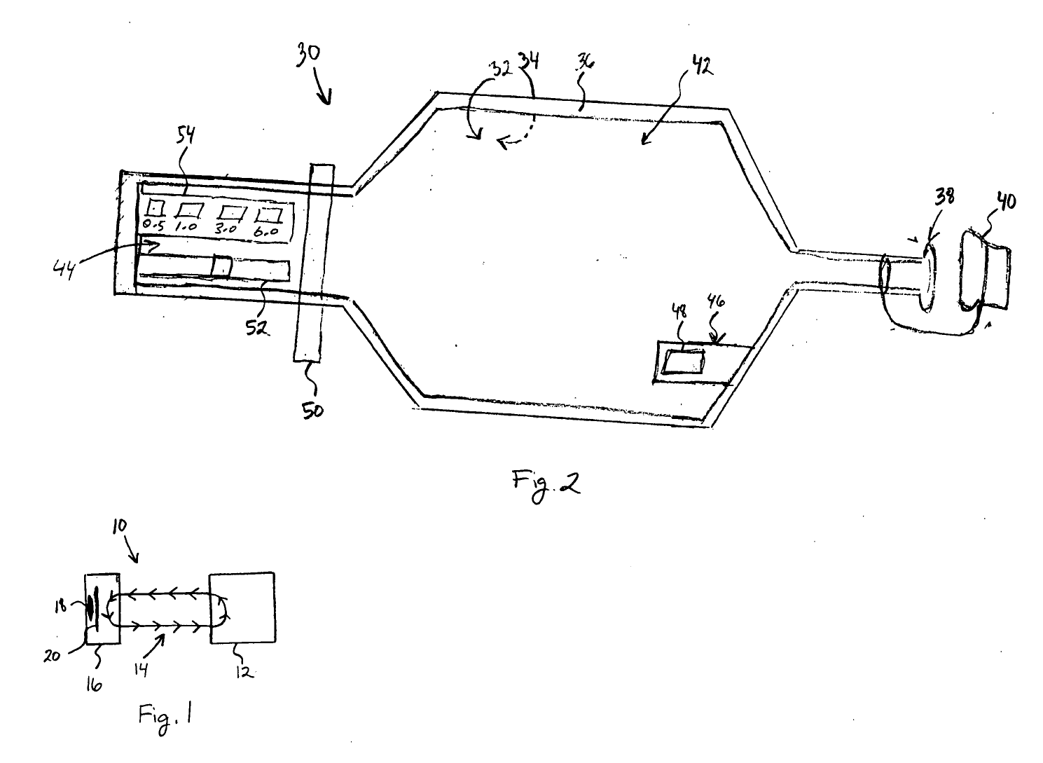

FIG. 1 illustrates a schematic view of an exemplary thermal control system 10 that includes a unit 12 that produces heat during operation. An aqueous-based coolant, for example, circulates through conduits 14 between a heat exchanger 16 and the unit 12 to remove the heat from the unit 12 and to maintain a preferred operating temperature of the unit 12. In one example, the aqueous-based coolant includes a biocide agent, such as glutaraldehyde, to destroy biological organisms in the aqueous-based coolant. Other possible biocide agents include but are not limited to amine functional groups, formaldehyde release agents, nitrites, pyridines, thiazoles, imidazoles, nitros, amines, anilides, quinolines, and mixtures thereof.

The heat exchanger 16 includes anhydrous ammonia 18 that cools the aqueous-based coolant across an interface 20 in the heat exchanger 16. That is, under typical operating conditions the interface 20 physically separates the anhydrous ammonia 18 from the aqueous-based coolant. However, under certain failure conditions the anhydrous ammonia 18 leaks across the interface 20 into the aqueous-based coolant. The ammonia content in the aqueous-based coolant is measured periodically to detect leaking of the anhydrous ammonia.

FIG. 2 illustrates a cross-sectional schematic view of a flexible sample bag 30 used to measure an amount of ammonia or other chemical in an aqueous-based coolant sample. The flexible sample bag 30 is fabricated from a clear plastic material, such as polytetrafluoroethylene, polyethylene, or other plastic material. In the example embodiment, the flexible sample bag 30 includes a front plastic piece 32 and a back plastic piece 34 that are heat sealed together around a perimeter of the flexible plastic bag 30 at a seam 36.

The flexible sample bag 30 includes an inlet 38 for introducing an aqueous-based coolant sample into the flexible sample bag 30. The inlet 38 includes a cap 40, such as a male luer lock cap or other cap, tethered to the inlet 38 for covering the inlet 38 and preventing an aqueous-based coolant sample from escaping the flexible sample bag 30. When the cap is positioned on the inlet 38 the cap 40 forms a seal with the inlet 38 that is sufficient to prevent a liquid sample from escaping.

The inside of the flexible sample bag 30 includes a first chamber 42 and a second chamber 44 that is fluidly connectable to the first chamber 42. In the example shown, the first chamber 42 and the second chamber 44 are unitarily formed such that the first chamber 42 and the second chamber 44 are not physically separable, although other configurations that include two physically separable fluidly connectable chambers are within the scope of the invention. The first chamber 42 includes a pH adjuster 46 for adjusting the pH of an aqueous-based coolant sample inside of the first chamber 42. That is, pH adjustment conducted in the first chamber 42 is separated from the second chamber 44. In the example shown, the pH adjuster 46 is attached to the flexible sample bag 30 to prevent entirely free movement of the pH adjuster 46 inside the first chamber 42. The pH adjuster 46 includes a metal hydroxide on a pad 48, such as a cellulose mesh. The metal of the metal hydroxide is an alkali metal or an alkaline earth metal. In one example, the metal hydroxide is sodium hydroxide.

The first chamber 42 is fluidly connectable to the second chamber 44. A closure member 50, such as a clip, is removably positioned between the first chamber 42 and second chamber 44 to either prevent or allow fluid flow between the first chamber 42 and the second chamber 44.

The second chamber 44 includes a chemical measuring device 52. In one example, the chemical measuring device 52 is a colorimetric test strip, or other simple colorimetric device, for measuring the amount of ammonia in an aqueous-based coolant sample. The chemical measuring device 52 is attached to the flexible plastic bag 30 in one example to prevent entirely free movement of the chemical measuring device 52 inside the second chamber 44. An indicator 54 is located adjacent to the chemical measuring device 52 inside of the second chamber 44 and is also attached to the flexible plastic bag 30. In the example shown, the indicator 54 is a colorimetric indicator for comparison to the colorimetric test strip and determination of the amount of ammonia in the aqueous-based coolant sample.

In one example application, the flexible sample bag 30 is used under microgravity conditions, such as on the International Space Station. The flexible sample bag 30 may provide the benefits of safely containing an aqueous-based coolant sample under microgravity conditions while allowing manipulation of the sample and adjustment of the pH of the sample. The flexible sample bag 30 may also find utility in non-microgravity applications requiring a simple apparatus and method for measuring ammonia content in an aqueous sample.

In one example, an operator measures the amount of ammonia in an aqueous-based coolant sample that contains a glutaraldehyde biocide agent. The glutaraldehyde has been shown experimentally to mask the ammonia in the aqueous-based coolant sample by forming an intermediate compound that is not detected by the chemical measuring device 52. The aqueous-based coolant sample has an initial pH of about 8.3, although higher or lower pH levels may be used. The operator introduces a predetermined volume of the aqueous-based coolant sample into the first chamber 42 through the inlet 38. The cap 40 is closed over the inlet 38 to seal the flexible sample bag 30. The operator then manipulates the aqueous-based coolant sample into contact with the pH adjuster 46. The clear and flexible plastic that forms the flexible sample bag 30 allows the operator to see the aqueous-based coolant sample inside of the first chamber 42 and to manually manipulate the aqueous-based coolant sample through the flexible sample bag 30. In one example, the operator uses his fingers to move the front plastic piece 32 and/or back plastic piece 34 to move the aqueous-based coolant sample inside of the flexible bag 30.

The operator contacts the aqueous-based coolant sample and the pH adjuster for a predetermined amount of time to ensure that a predetermined amount of sodium hydroxide dissolves in the aqueous-based coolant sample. The predetermined amount of sodium hydroxide corresponds to the predetermined volume of aqueous-based coolant sample such that the resulting pH of the pH adjusted aqueous-based coolant sample is about 10. In other examples, the pH may be adjusted to other desirable pH levels. If other metal hydroxides are used, the predetermined amount required to adjust the pH of the aqueous-based coolant sample to a pH of 10 may be different and may be determined by workers of ordinary skill in the art.

After dissolving the sodium hydroxide in the aqueous-based coolant sample, the operator removes the closure member 50 that separates the first chamber 42 and second chamber 44 and manually manipulates the adjusted pH aqueous-based coolant sample into the second chamber 44. The closure member 50 is re-positioned between the first chamber 42 and second chamber 44 to prevent the pH adjusted aqueous-based coolant sample from retreating into the first chamber 42. The operator then manipulates the pH adjusted aqueous-based coolant sample to contact the chemical measuring device 52, for example a colorimetric test strip. The calorimetric test strip changes color in response to contact with the pH adjusted aqueous-based coolant sample, but would not have changed color or would have changed color to a lesser degree if contacted with the aqueous-based coolant sample before the pH change.

A first color indicates a small amount of ammonia was present in the initial aqueous-based coolant sample while a second, third, or forth different color might indicate larger amounts of ammonia. Alternatively, a range of different shades of the same color, such as a light red ranging to a dark red, may indicate different amounts of ammonia.

In one example, the colorimetric test strip changes color in response to an amount of ammonia in the pH adjusted aqueous-based coolant sample. In another example the colorimetric test strip changes color in response to an ammonia/glutaraldehyde intermediate compound produced at least in part from the changing of the pH of the aqueous-based coolant sample. In yet another example, the calorimetric test strip changes color in response to a carbinolamine intermediate compound derived from ammonia and the glutaraldehyde biocide. And in another example, the colorimetric test strip changes color in response to a combination of ammonia and ammonia/glutaraldehyde intermediate compounds.

The operator then compares the color of the calorimetric test strip to colors on the adjacent indicator 54. Each different color or shade of the same color on the indicator 54 represents a different amount of ammonia. The operator visually matches the color of the colorimetric test strip to a color on the indicator 54 to determine the amount of ammonia. The color change of the colorimetric test strip represents the amount of ammonia in the initial aqueous-based coolant sample. Conveniently, the entire flexible sample bag 30 may be disposed of after completing the measurement.

Utilizing the inventive method and apparatus may provide the benefit of more accurately measuring the amount of ammonia in an aqueous sample. That is, the amount of ammonia present in the aqueous-based coolant sample as determined by using the invention may be closer to the actual amount of ammonia in the aqueous-based coolant sample than may be measured using previous methods that do not utilize pH adjustment.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A chemical measuring apparatus for measuring a chemical sample comprising:
a flexible sample bag for receiving the chemical sample therein; and
a sample adjuster for chemically altering the chemical sample inside of said sample bag.

2. The apparatus as recited in claim 1, wherein said flexible sample bag includes first and second fluidly connectable chambers.

3. The apparatus as recited in claim 2, wherein said first and second fluidly connectable chambers are unitarily formed such that the first chamber is not physically separable from the second chamber.

4. The apparatus as recited in claim 2, further comprising a closure member that is removably securable between said first and second fluidly connectable chambers to prevent fluid communication between said first and second chambers.

5. The apparatus as recited in claim 2, wherein said first and second fluidly connectable chambers comprise at least two flexible plastic pieces sealed together at a seam around a perimeter of the flexible sample bag.

6. The apparatus as recited in claim 1, further comprising a chemical measuring device disposed in said flexible sample bag.

7. The apparatus as recited in claim 6, wherein said chemical measuring device comprises a colorimetric test strip attached inside the flexible sample bag.

8. The apparatus as recited in claim 7, further comprising a colorimetric indicator located adjacent to said calorimetric test strip.

9. The apparatus as recited in claim 1, wherein said sample adjuster comprises a pH adjuster for chemically altering the pH of the chemical sample.

10. The apparatus as recited in claim 9, wherein said pH adjuster comprises a metal hydroxide.

11. The apparatus as recited in claim 10, wherein the metal of said metal hydroxide is selected from the group of periodic table elements consisting of alkali metals and alkaline earth metals.

12. The apparatus as recited in claim 11, wherein said metal is sodium.

13. A method of measuring the amount of a chemical in a sample comprising the steps of:
(a) providing a sample that includes:
a chemical that is to be measured; and
an agent that at least partially masks the chemical in the sample;
(b) unmasking the chemical in the sample using a pH adjuster to change a pH of the sample; and
(c) measuring the amount of the chemical in the sample.

14. The method as recited in claim 13, wherein the step (a) comprises providing an aqueous sample and a biocide as the agent.

15. The method as recited in claim 14, wherein the biocide includes chemical substances from the group including amine functional groups, formaldehyde release agents, nitriles, pyridines, thiazoles, imidazoles, nitros, amines, anilides, quinolines, and mixtures thereof.

16. The method as recited in claim 14, wherein the step (a) comprises providing a substance that includes glutaraldehyde as the biocide.

17. The method as recited in claim 13, wherein the amount of the chemical in the sample as measured in step (c) is greater than a measured amount of the chemical in the sample prior to performing step (b).

18. The method as recited in claim 17, wherein the measured amount of the chemical in the sample prior to performing step (b) is approximately zero.

19. The method as recited in claim 13, wherein the step (b) comprises using a metal hydroxide as the pH adjuster to change the pH of the sample.

20. The method as recited in claim 19, wherein the step (b) comprises providing sodium hydroxide as the metal hydroxide.

21. The method as recited in claim 19, wherein the step (b) comprises using a predetermined amount of metal hydroxide to change the pH of a predetermined amount of the sample to a predetermined pH level.

22. A process of measuring the amount of a chemical in a sample comprising:
manipulating the sample inside of a flexible sample bag to bring the sample in contact with a pH adjuster to form a pH adjusted sample.

23. The method as recited in claim 22, wherein said step further comprises manually manipulating the flexible sample bag to manipulate the sample while under microgravity conditions.

24. The method as recited in claim 22, further comprising the steps of introducing the sample into a first chamber in which the pH adjuster is disposed through a first chamber inlet and capping the first chamber inlet to prevent the sample from escaping.

25. The method as recited in claim 24, further comprising the step of fluidly connecting the first chamber to the second chamber.

26. The method as recited in claim 25, further comprising the step of moving a closure member to separate the first chamber from the second chamber.

27. The method as recited in claim 26, further comprising the steps of manipulating the pH adjusted sample in the second chamber to bring the pH adjusted sample in contact with a measuring device and reading a resulting color from the measuring device.

28. The method as recited in claim 27, further comprising the step of comparing the resulting color with a colorimetric indicator located adjacent to the measuring device in the second chamber to determine the amount of the chemical.
